(19) United States
(12) Patent Application Publication
(10) Pub. No.: US 2007/0171266 A1
(43) Pub. Date: Jul. 26, 2007

(54) Recording liquids

(75) Inventors: Michael Kluge, Ludwigshafen (DE); Ulrike Hees, Mannheim (DE); Dieter Freyberg, Einselthum (DE); Henriette Schwindt, Dirmstein (DE); Karin Linss, Neustadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengelellschaft, Ludwigshafen (DE)

(21) Appl. No.: 10/590,811

(22) PCT Filed: Feb. 19, 2005
(86) PCT No.: PCT/EP05/01760

§ 371 Date: Aug. 25, 2006

(30) Foreign Application Priority Data
Feb. 26, 2004 (DE) 10 2004 009 942.1

(51) Int. Cl. C09D 11/02; G01D 11/00

(52) U.S. Cl. 347/100; 106/31.27; 106/31.58; 106/31.57; 106/31.59

(57) ABSTRACT

Aqueous recording fluids comprising (a) at least one disperse dye, (b) at least two wetting agents.

The present invention relates to aqueous recording fluids comprising

(a) at least one disperse dye,

(b) at least two wetting agents.

Recording fluids and especially inks which are used in the ink jet process (such as Thermal Ink Jet, Piezo Ink Jet, Continuous Ink Jet, Valve Jet, transfer printing processes) have to meet a whole series of requirements: They have to have viscosity and surface tension suitable for printing, they have to be stable in storage, i.e., they should not coagulate or flocculate, and they must not lead to cloggage of printer nozzles, which can be problematical especially in the case of inks comprising dispersed, i.e., undissolved, colorant particles. Stability in storage further requires of these recording fluids and especially inks that the dispersed colorant particles do not sediment. Furthermore, in the case of Continuous Ink Jet, the inks shall be stable to the addition of conducting salts and be free from any tendency to floc out with an increase in the ion content. In addition, the prints obtained have to meet colorists' requirements, i.e., show high brilliance and depth of shade, and have good fastnesses, for example rubfastness, lightfastness, waterfastness and wet rubfastness, if appropriate after aftertreatment such as fixation for example, and good drying characteristics.

It is a further requirement that the inks dry rapidly on the substrate in order that images or characters to be printed do not bleed and for example the ink droplets of different colors do not mingle. The production of needle-sharp prints requires in this connection not only print dry time minimization but also bleed control for the ink droplets on the substrate during the print dry time. An ink where the droplets do not bleed is said to have good holdout. Prior art ink holdout, or print definition, leaves something to be desired.

EP 1 153 992 describes pigmented inks wherein pigment particles are enveloped with a resin which has an anionic group, the ink comprising 0.1% to 5% by weight of an acetylene glycol surfactant and/or a polysiloxane of the formula A1 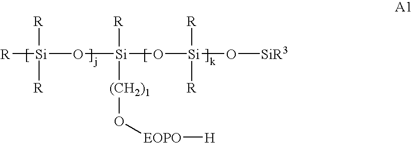
as well as enveloped pigment. In the formula diagram shown, j and k are each 1 or more, the R radicals are the same or different and are each C₁-C₆-alkyl and EOPO—H represents at least one ethylene oxide unit or at least one propylene oxide unit or at least one polyalkylene oxide unit in which ethylene oxide and propylene oxide units may be arranged randomly or in block form.

EP 1 234 859 claims a pigmented ink comprising at least one compound of the general formula A2 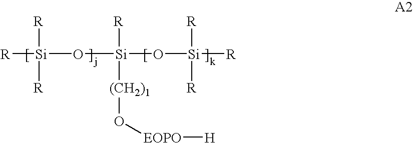
where the variables are each as defined above.

U.S. Pat. No. 6,241,811 claims an ink formulation comprising an alkoxylated or nonalkoxylated acetylene glycol compound.

EP 1 333 048 discloses ink formulations having solids contents in the range from 20% to 60% which each comprise a specifically substituted acetylenediol.

EP 1 295 916 discloses inks for the ink jet process which comprise a completely polymer-enveloped pigment or a completely polymer-enveloped dye, water and at least one specific compound selected from acetylene glycol compounds, acetylene alcohols, glycol ethers or 1,2-alkylene glycols. Completely polymer-enveloped pigments and dyes are disclosed by EP 1 295 916 to be made for example by preparing the required polymer in the presence of the respective pigment and dye to be completely enveloped. The use of completely polymer-enveloped pigment is essential according to EP 1 295 916 because it is otherwise not possible to attain satisfactory images (page 12 line 54 to page 13 line 4).

However, it has been determined that the printing properties of prior art inks are still in need of improvement. For example, some prior art inks are still very foaming.

The present invention has for its object to provide recording fluids and especially inks for the ink jet process which do not have the disadvantages mentioned above. The present invention further has for its object to provide a process for producing improved recording fluids and especially inks for the ink jet process. The present invention further has for its object to provide printed substrates.

We have found that this object is achieved by the recording fluids defined at the beginning.

In what follows, recording fluids will also be referred to as inks and inks for the ink jet process.

The recording fluids of the present invention comprise (a) at least one disperse dye.

Specific examples of representative disperse dyes are:
C.I. Disperse Yellow 2, 4, 5, 6, 7, 8, 10, 11, 11:1, 12, 13, 14, 15, 16, 17, 18, 19, 20, 21, 22, 23, 24, 25, 26, 27, 28, 29, 30, 31, 32, 33, 34, 35, 36, 37, 38, 40, 41, 42, 43, 44, 45, 46, 47, 48, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 179, 180, 181, 182, 183, 184, 184:1, 198, 200, 201, 202, 203, 204, 205, 206, 207, 208, 209, 210, 211, 212, 213, 214, 215, 216, 217, 218, 219, 220, 221, 222, 223, 224, 225, 226, 227 and 228;
C.I. Disperse Orange 2, 4, 5, 6, 7, 8, 9, 10, 12, 13, 14, 15, 16, 17, 18, 19, 20, 21, 22, 23, 24, 25, 25:1, 26, 27, 28, 29, 30, 31, 32, 33, 34, 35, 36, 38, 39, 40, 41, 41:1, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 77, 78, 79, 80, 81, 82, 83, 84, 85, 86, 87, 88, 89, 90, 91, 126, 127, 128, 129, 130, 131, 136, 137, 138, 139, 140, 141, 142, 143, 145, 146, 147 and 148;
C.I. Disperse Red 2, 3, 4, 5, 5:1, 6, 7, 8, 9, 10, 12, 13, 14, 15, 16, 18, 19, 20, 21, 22, 23, 24, 25, 26, 27, 28, 29, 30, 30:1, 31, 32, 33, 34, 35, 36, 38, 39, 40, 41, 43, 43:1, 46, 48, 50, 51, 52, 53, 54, 55, 55:1, 56, 58, 59, 60, 61, 63, 65, 66, 69, 70, 72, 73, 74, 75, 76, 77, 79, 80, 81, 82, 84, 85, 86, 86:1, 87, 88, 89, 90, 91, 92, 93, 94, 96, 97, 98, 100, 102, 103, 104, 105, 106, 107, 108, 109, 110, 111, 112, 113, 115, 116, 117, 118, 120, 121, 122, 123, 125, 126, 127, 128, 129, 130, 131, 132, 133, 134, 135, 136, 137, 138, 139, 140, 141, 142, 143, 144, 145, 146, 147, 148, 149, 150, 151, 151:1, 152, 153, 154, 155, 156, 157, 158, 159, 160, 161, 162, 163, 164, 165, 166, 167, 167:1, 168, 169, 170, 171, 172, 173, 174, 175, 176, 177, 178, 179, 180, 181, 182, 183, 184, 185, 186, 187, 188, 189, 190, 190:1, 191, 191:1, 192, 193, 194, 195, 211, 223, 224, 273, 274, 275, 276, 277, 278, 279, 280, 281, 302:1, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 338, 339, 340, 341, 342, 343, 344, 346, 347, 348, 349, 352, 356 and 367;
C.I. Disperse Violet 1, 2, 3, 4, 4:1, 5, 6, 7, 8, 9, 10, 11, 12, 13, 14, 15, 16, 17, 18, 19, 20, 21, 22, 23, 24, 25, 26, 27, 28, 29, 31, 33, 34, 35, 36, 37, 38, 39, 40, 41, 42, 43, 44, 45, 46, 47, 48, 49, 50, 51, 52, 53, 54, 55, 56, 57, 58, 59, 60, 70, 81, 86, 87, 88, 89, 91, 92, 93, 94, 96 and 97;
C.I. Disperse Blue 2, 4, 5, 6, 8, 9, 10, 11, 12, 13, 13:1, 14, 15, 16, 17, 18, 19, 20, 21, 22, 23, 23:1, 24, 25, 27, 28, 29, 30, 31, 32, 33, 34, 36, 38, 39, 40, 42, 43, 44, 45, 47, 48, 49, 51, 52, 53, 54, 55, 56, 58, 60, 60:1, 61, 62, 63, 64, 64:1, 65, 66, 68, 70, 72, 73, 75, 76, 77, 79, 80, 81, 81:1, 82, 83, 84, 85, 86, 87, 88, 89, 90, 91, 92, 93, 94, 95, 96, 97, 98, 99, 100, 101, 103, 104, 105, 107, 108, 109, 111, 112, 113, 114, 115, 116, 117, 118, 119, 121, 122, 123,125, 126, 127, 128, 130, 131, 132, 133, 134, 136, 137, 138, 139, 140, 141, 142, 143, 144, 145, 146, 147, 148, 149, 150, 151, 152, 153, 154, 155, 156, 158, 159, 160, 161, 162, 163, 164, 165, 165:2, 166, 167, 168, 169, 170, 171, 172, 173, 174, 175, 195, 281, 282, 283, 283:1, 284, 285, 286, 287, 288, 289, 290, 291, 292, 293, 294, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 349, 351 and 359;
C.I. Disperse Green 1, 2, 5, 6 and 9;
C.I. Disperse Brown 1, 2, 3, 4, 4:1, 5, 7, 8, 9, 10, 11, 18, 19, 20 and 21;

C.I. Disperse Black 1, 3, 4, 5, 6, 7, 8, 9, 10, 11, 12, 13, 14, 15, 20, 22, 24, 25, 26, 27, 28, 29, 29:1, 30, 31, 32, 33, 34 and 36;

Also suitable are the substituted benzodifuranone dyes whose basic structure conforms to the formula B.

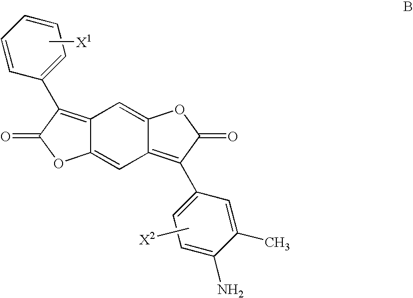

Benzodifuranone dyes of the formula B may be substituted on either or both of the phenyl rings. Useful substituents X¹ and X² include halogen, alkyl with interruption by nonadjacent oxygen atoms, alkoxy with or without interruption by oxygen atoms and substitution in the alkyl moiety, hydroxyl, substituted or unsubstituted amino, cyano, nitro and alkoxycarbonyl.

Also suitable is the dye of the following formula C:

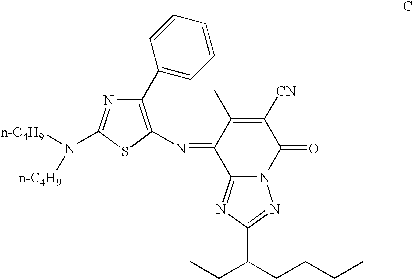

Further examples of suitable disperse dyes are recited in WO 97/46623, WO 98/24850 and WO 99/29783.

The recording fluids of the present invention may comprise mixtures of two or more different disperse dyes. Preferably, however, the recording fluids of the present invention do not comprise mixtures of two or more different disperse dyes, but only one disperse dye.

The recording fluids of the present invention comprise one or more disperse dyes which is/are preferably in particulate form, i.e., in the form of particles. The particles may be regular or irregular in shape in that, for example, the particles may have a spherical or substantially spherical shape or a needle (acicular) shape.

Colorants in particulate form which are included in the recording fluids of the present invention should be very finely divided. It is preferable for 95% by weight and more preferable for 99% by weight of the colorant particles to have a median particle diameter of 1 μm, preferably of 0.5 μm and especially of 0.3 μm.

In a preferred embodiment of the present invention, an inventive recording fluid comprises from 10 to 100 g/l and preferably from 12 to 70 g/l of colorant in preferably particulate form.

Aqueous recording fluids according to the present invention further comprise

(b) at least two wetting agents.

Preferably, at least two wetting agents are selected from alkoxylated alcohols, alkoxylated or nonalkoxylated silicones, acetylene derivatives, alkylpolyglucosides, sugar ester alkoxylates, fluorosurfactants, anionic surfactants and cationic surfactants.

Alkoxylated alcohols for the purposes of the present invention are singly or multiply, preferably up to 30-tuply alkoxylated alcohols of the general formula I
R¹—O-(AO)ₓ—H I
where:
R¹ is selected from C₅-C₃₀-alkyl, unsubstituted or substituted with one or two hydroxyl groups, wherein one or else two nonadjacent CH₂ groups may be replaced by oxygen, examples being n-pentyl, iso-pentyl, iso-amyl, n-hexyl, n-heptyl, n-octyl, 2-ethylhexyl, n-nonyl, n-decyl, iso-decyl, n-undecyl, n-dodecyl, n-tridecyl, n-tetradecyl, n-pentadecyl, n-hexadecyl, n-octadecyl, n-eicosyl and the radicals I a to I c 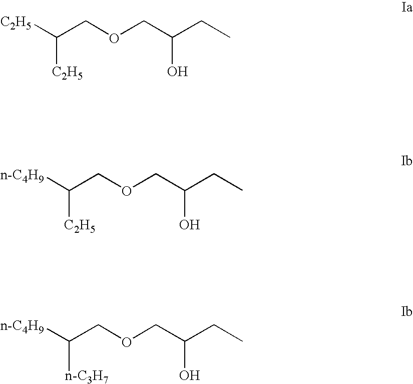
AO represents identical or different alkylene oxide units, for example propylene oxide units, butylene oxide units and especially ethylene oxide units.
x is an integer in the range from 1 to 100, preferably up to 50 and more preferably from 2 to 30.

Alkoxylated silicones can be selected for example from compounds which comprise structural elements of the formulae II a to II e 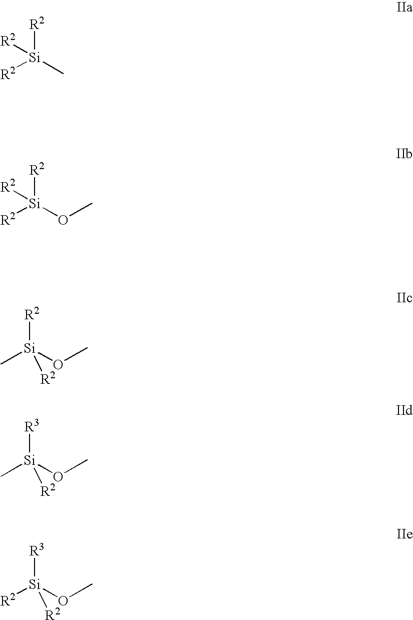
and preferably are constructed of structural elements of the formulae II a to II e.

The variables in the formulae II a to II e are defined as follows:
R² is at each occurrence the same or different and independently selected from C₁-C₁₀-alkyl, branched or unbranched, such as methyl, ethyl, n-propyl, iso-propyl, n-butyl, iso-butyl, sec-butyl, tert-butyl, n-pentyl, isopentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl, more preferably C₁-C₄-alkyl such as methyl, ethyl, n-propyl, iso-propyl, n-butyl, iso-butyl, sec-butyl and tert-butyl, most preferably methyl;
   and C₆-C₁₄-aryl, such as phenyl, α-naphthyl, β-naphthyl, especially phenyl.
R³ is a radical of the general formula III 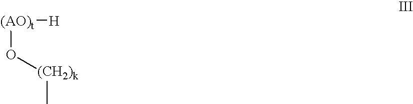
   where
AO is as defined above,
t is an integer in the range from 1 to 100, preferably 1 or in the range from 3 to 50 and most preferably from 5 to 30,
k is an integer in the range from 1 to 10 and preferably in the range from 3 to 5.

The abovementioned alkoxylated silicones are typically synthesized in the form of mixtures. By an alkoxylated silicone is therefore meant in the present invention that alkoxylated or nonalkoxylated silicone which corresponds to the number average mean as far as units of the general formulae II a to II e and t are concerned.

Preferably, at least one alkoxylated or nonalkoxylated silicone included as a wetting agent in recording fluids according to the present invention comprises at least one structural unit of the general formula II d or II e. More preferably, at least one alkoxylated or nonalkoxylated silicone included as a wetting agent in recording fluids according to the present invention comprises precisely one structural unit of the general formula II d or II e.

The abovementioned included alkoxylated or nonalkoxylated silicones are obtainable for example by hydrolysis of silane mixtures, for example silanes of the formulae (R²)₂SiX₂, (R²)₃SiX, (R²)₂R³SiX and R²R³SiX₂, in each of which X is selected from hydrogen and halogen, especially chlorine, and if appropriate subsequent alkoxylation.

Acetylene derivatives can preferably be selected from alkoxylated or nonalkoxylated acetylene alcohols and alkoxylated or nonalkoxylated acetylenediols.

Alkoxylated acetylene alcohols are preferably compounds of the general formula IV 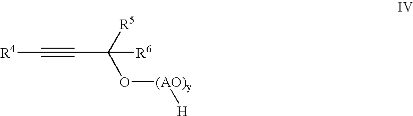
where:
R⁴ is selected C₁-C₁₀-alkyl, branched or unbranched, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl, more preferably C₁-C₄-alkyl such as methyl, ethyl, n-propyl, iso-propyl, n-butyl, iso-butyl, sec-butyl and tert-butyl;
   and hydrogen;
R⁵ and R⁶ are the same or different and selected from
   C₁-C₁₀-alkyl, branched or unbranched, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl, more preferably C₁-C₄-alkyl such as methyl, ethyl, n-propyl, iso-propyl, n-butyl, iso-butyl, sec-butyl and tert-butyl;
   and hydrogen;
y is an integer in the range from 1 to 50, preferably up to 30 and more preferably up to 10.

In a preferred embodiment of the present invention R⁵ and R⁶ are each or both not hydrogen.

In a preferred embodiment of the present invention R⁵ and R⁶ are each or both methyl.

In a particularly preferred embodiment of the present invention R⁵ is methyl and R⁶ is C₁-C₁₀-alkyl.
AO is as defined above.

Alkoxylated or nonalkoxylated acetylenediols are preferably compounds of the general formula V 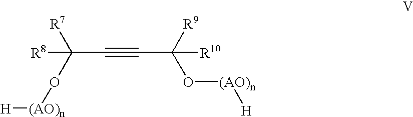
where:
R⁷, R⁸, R⁹, R¹⁰ are each the same or different and selected from
   C₁-C₁₀-alkyl, branched or unbranched, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl, more preferably C₁-C₅-alkyl such as methyl, ethyl, n-propyl, iso-propyl, n-butyl, iso-butyl, sec-butyl, tert-butyl and isopentyl;
   and hydrogen;
n is at each occurrence the same or different and selected from integers in the range from 0 to 50, preferably up to 30 and more preferably up to 10;
AO is as defined above.

In a preferred embodiment of the present invention R⁹ and R⁷ are both not hydrogen.

In a preferred embodiment of the present invention R⁹ or R⁷ is methyl.

In a particularly preferred embodiment of the present invention R⁷ and R⁹ are both methyl and R⁸ and R¹⁰ are both C₁-C₁₀-alkyl, especially isobutyl.

An alkylpolyglucoside for the purposes of the present invention is preferably a glucose etherified with C₁-C₂₀-alkanol and preferably with C₁₂-C₂₀-alkanol at the C₁ position. Their manufacturing operation is such that alkylpolyglucosides are generally contaminated with C₁-C₆-linked di- and polyglucosides which may be etherified with C₁-C₂₀-alkanol. In one embodiment of the present invention 1.3 equivalents of sugar are linked with one equivalent of C₁-C₂₀-alkanol.

Sugar ester alkoxylates for the purposes of the present invention are preferably sugar alcohols esterified singly or multiply with fatty acids and alkoxylated with 5 to 80 equivalents of alkylene oxide, especially with ethylene oxide. Preferred sugar ester alkoxylates are selected from alkoxylated sorbitan fatty acids, preferably sorbitol singly or multiply esterified with fatty acids and alkoxylated with 5 to 80 equivalents of alkylene oxide, especially ethylene oxide.

Fluorosurfactants for the purposes of the present invention are preferably perfluoro-C₈-C₉-carboxylic acids in the form of their alkali metal salts and preferably their sodium salts.

Anionic surfactants for the purposes of the present invention are preferably fatty acid salts, especially alkali metal salts of fatty acids such as for example stearic acid and palmitic acid.

Cationic surfactants for the purposes of the present invention are preferably C₈-C₂₀-alkyltrimethylammonium salts, especially chlorides or bromides.

The above-recited alkoxylated alcohols, alkoxylated acetylene alcohols, acetylene glycols and sugar ester alkoxylates are typically synthesized in the form of mixtures, and the components of the as-synthesized mixtures typically differ in their degree of alkoxylation. The variables x, y and n therefore represent the number average degree of alkoxylation, which can be determined by methods known to one skilled in the art, such as gel permeation chromatography (GPC) for example. A mixture obtained by customary synthesis is for the purposes of the present invention not defined as two different wetting agents.

In one embodiment of the present invention colorant preparations according to the present invention comprise up to 5% by weight, based on the total weight of the recording fluid of the present invention, of wetting agents (b), preferably up to 2% by weight and more preferably up to 1.5% by weight.

In one embodiment of the present embodiment of the present invention recording fluids according to the present invention comprise up to 5 different wetting agents (b1), (b2), (b3), (b4) and (b5), preferably up to 3 different wetting agents (b1), (b2) and (b3), more preferably two wetting agents (b1) and (b2).

In a preferred embodiment of the present invention recording fluids according to the present invention comprise two different wetting agents (b1) and (b2) in weight fractions in the range from 1:10 to 10:1, preferably in the range from 1:5 to 5:1, and more preferably in the range from 3:1 to 1:3.

In a preferred embodiment of the present invention recording fluids according to the present invention comprise two different wetting agents (b1) and (b2) of which one (b1) is selected from alkoxylated silicones and one (b2) from alkoxylated or nonalkoxylated acetylenediols.

In another preferred embodiment of the present invention recording fluids according to the present invention comprise two different wetting agents (b1) and (b2) of which one (b1) is selected from nonalkoxylated acetylenediols and one (b2) from alkoxylated acetylenediols.

In one embodiment of the present invention recording fluids according to the present invention comprise

(c) at least one dispersant.

In one embodiment of the present invention recording fluids according to the present invention comprise

(a) if appropriate at least one dispersant,

(b) water and

(c) if appropriate further assistants.

Very particularly preferred examples of dispersants (c) are for example alkoxylated and partially sulfated alkylphenols, for example the substances described in U.S. Pat. No. 4,218,218, or condensation products of naphthalenesulfonic acid and formaldehyde or mixtures of arylsulfonic acid-formaldehyde condensation products as described for example in U.S. Pat. No. 5,186,846.

Further particularly useful dispersants are selected from multiply ethoxylated and/or propoxylated diamines.

Useful dispersants further include maleic acid-acrylic acid copolymers, especially those having a molecular weight Mₙ in the range from 2000 to 10 000 g/mol, which are useful in the form of random copolymers or block copolymers. Useful dispersants further include N-vinylpyrrolidone homopolymers and (meth)acrylate-N-vinylpyrrolidine copolymers, especially those N-vinylpyrrolidone homopolymers and acrylate-N-vinylpyrrolidine copolymers having a molecular weight Mₙ in the range from 2000 to 10 000 g/mol, in the form of random copolymers or block copolymers.

Recording fluids according to the present invention may comprise for example from 0.1% to 15% by weight, preferably from 1% to 10% by weight of dispersant, based on the total weight of recording fluid according to the present invention.

Recording fluids according to the present invention may comprise organic solvents.

Low molecular weight polytetrahydrofuran is a preferred solvent; it can be used alone or preferably mixed with one or more high-boiling water-soluble or -miscible organic solvents.

The preferred low molecular weight polytetrahydrofuran typically has an average molecular weight M_{w} in the range from 150 to 500 g/mol, preferably in the range from 200 to 300 g/mol and more preferably of about 250 g/mol (in keeping with a molecular weight distribution).

The preferred low molecular weight polytetrahydrofuran is preparable in a known manner by cationic polymerization of tetrahydrofuran. The products are linear polytetramethylene glycols.

When the preferred low molecular weight polytetrahydrofuran is used as an additive in admixture with further organic solvents, the further organic solvents employed will generally be high-boiling and hence water-retaining organic solvents that are soluble in or miscible with water. High-boiling solvents generally have a boiling point>100° C. at atmospheric pressure.

Useful solvents further include polyhydric alcohols, preferably unbranched and branched polyhydric alcohols having from 2 to 8 and especially from 3 to 6 carbon atoms, such as ethylene glycol, 1,2-propylene glycol, 1,3-propylene glycol, 1,2-pentanediol, 1,2-hexanediol, glycerol, erythritol, pentaerythritol, pentitols such as arabitol, adonitol and xylitol and hexitols such as sorbitol, mannitol and dulcitol, most preferably combinations of glycerol and 1,2-pentanediol or 1,2-hexanediol.

Useful solvents further include polyethylene glycols and polypropylene glycols (which is also to be understood as meaning the lower polymers (di-, tri- and tetramers)) and their mono (especially C₁-C₆, in particular C₁-C₄) alkyl ethers. Preference is given to polyethylene and polypropylene glycols having average molecular weights in the range from 100 to 1500 g/mol, especially in the range from 200 to 800 g/mol, and in particular in the range from 300 to 500 g/mol. Examples which may be mentioned are diethylene glycol, triethylene glycol, tetraethylene glycol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, di-, tri- and tetra-1,2- and -1,3-propylene glycol and di-, tri- and tetra-1,2- and -1,3-propylene glycol monomethyl, monoethyl, monopropyl and monobutyl ethers. Useful solvents further include pyrrolidone and N-alkylpyrrolidones whose alkyl chain preferably comprises from 1 to 4 and especially 1 or 2 carbon atoms. Examples of useful alkylpyrrolidones include N-methylpyrrolidone, N-ethylpyrrolidone and N-(2-hydroxyethyl)pyrrolidone.

Examples of particularly preferred solvents include 1,2-propylene glycol, 1,3-propylene glycol, glycerol, sorbitol, diethylene glycol, polyethylene glycol (M_{w} 300 to 500 g/mol), diethylene glycol monobutyl ether, triethylene glycol monobutyl ether, pyrrolidone, N-methylpyrrolidone and N-(2-hydroxyethyl)pyrrolidone.

The preferred low molecular weight polytetrahydrofuran can also be mixed with one or more (for example two, three or four) of the solvents recited above.

In one embodiment of the present invention recording fluids according to the present invention may comprise from 0% to 45% by weight, preferably from 5% to 30% by weight, more preferably from 10% to 25% by weight and most preferably from 10% to 20% by weight of one or more organic solvents, each percentage being based on the total weight of the recording fluid according to the present invention.

Organic solvents for the purposes of the present invention are liquid at room temperature.

Recording fluids according to the present invention in a specific version of the present invention comprise no organic solvents which have a boiling point below 247° C., measured at atmospheric pressure. By “no solvents” as used herein is meant that the fraction of organic solvents having a boiling point of below 247° C. that may be present as impurity or as a contaminant is in total less than 0.1% by weight, preferably less than 0.05% by weight and more preferably less than 0.01% by weight. Examples of organic solvents having a boiling point below 247° C. are for example ethylene glycol, diethylene glycol, N-methylpyrrolidone, propylene glycol, propylene carbonate, diethylene monomethyl ether, diethylene monoethyl ether, diethylene mono-n-butyl ether, di-n-butyl ether, 1,2-dimethoxyethane, isopropanol and ethanol.

The organic solvent or solvents, including especially the particularly preferred solvent combinations mentioned, may advantageously be supplemented with urea (preferably from 0.1% to 5% by weight, based on the weight of the recording fluid according to the present invention or of the ink jet process ink according to the present invention) to further enhance the water-retaining effect of the solvent or solvent mixture.

Recording fluids according to the present invention may comprise further assistants (e) of the kind which are customary especially for aqueous ink jet inks and in the printing and coatings industry. Examples of such assistants include erythritol, pentitols such as arabitol, adonitol and xylitol and hexitols such as sorbitol, mannitol and dulcitol. Further examples are polyethylene glycols having an M_{w} in the range from more than 2000 g/mol to about 10 000 g/mol and preferably up to 800 g/mol. Further examples are preservatives such as for example 1,2-benzisothiazolin-3-one and its alkali metal salts, viscosity regulators, flow agents, wetters (e.g., wetting surfactants based on ethoxylated or propoxylated fatty or oxo alcohols, propylene oxide-ethylene oxide block copolymers, alkylphenol ether sulfates, alkylpolyglycosides, alkyl phosphonates, alkylphenyl phosphonates, alkyl phosphates, alkylphenyl phosphates, anti-settlers, luster improvers, lubricants, adhesion improvers, anti-skinning agents, delusterants, emulsifiers, stabilizers, hydrophobicizers, light control additives, hand improvers, antistats, bases such as for example K₂CO₃ or acids, specific carboxylic acids such as for example lactic acid or citric acid for regulating the pH. When these agents are part of recording fluids according to the present invention, their total amount will generally be 2% by weight and especially 1% by weight, based on the weight of the recording fluids according to the present invention.

In one embodiment of the present invention recording fluids according to the present invention have a dynamic viscosity in the range from 1 to 30 mPa·s, preferably in the range from 1 to 20 mPa·s and more preferably in the range from 2 to 15 mPa·s, determined at 20° C. in each case.

The surface tension of recording fluids according to the present invention at 20° C. is generally in the range from 20 to 70 mN/m, especially in the range from 20 to 40 mN/m and more preferably in the range from 25 to 35 mN/m.

The pH of recording fluids according to the present invention is generally in the range from 5 to 10 and preferably in the range from 7 to 9.

Recording fluids according to the present invention comprise (d) water, preferably deionized (demineralized or completely ion-free) water. They are therefore referred to herein as aqueous recording fluids. The preferred water content is not less than 30% by weight, preferably not less than 45% by weight and more preferably not less than 65% by weight.

In one embodiment of the present invention recording fluids according to the present invention comprise less than 500 ppm of free heavy metal ions, preferably less than 400 ppm, based in each case on the mass of the recording fluid according to the present invention. Specific examples of heavy metal ions are Cu²⁺, Co²⁺, Co³⁺, Fe²⁺, Fe³⁺, Ni²⁺, Zn²⁺, Ca²⁺. More particularly, recording fluids according to the present invention and ink jet process inks according to the present invention comprise up to 300 ppm of iron.

Recording fluids according to the present invention which have a heavy metal ion content of less than 500 ppm are producible for example by using purified pigments or by employing steps such as precipitating, salting out, ion exchange processes, filtration, electrolytic processes or other conventional deionization processes during the production of recording fluids according to the present invention. It is similarly possible to use appropriately purified organic solvent and completely ion-free water.

In one embodiment of the present invention recording fluids according to the present invention comprise less than 0.05% by weight of chloride, determined as sodium chloride.

Recording fluids according to the present invention which are used as inks for the ink jet process are observed to have a very small surface tension difference in the short-term range (0.1 seconds or less), meaning that, when the dynamic surface tension is determined according to German industrial standard DIN 53914, the values obtained are close to the static surface tension. In other words, the difference between static and dynamic surface tension after 0.1 seconds or sooner is generally in the range from 0.01 to 0.45 mN/m and preferably in the range from 0.1 to 0.4 mN/m.

A further aspect of the present invention is a process for producing recording fluids according to the present invention, hereinafter also referred to as production process according to the present invention. The production process according to the present invention customarily comprises one or more steps in which components of recording fluids according to the present invention are mixed. Such steps are carried out in customary mixing apparatuses, for example dissolvers, tanks and mills, including roll mills, ball mills or stirred media mills.

In one embodiment of the present invention the production process according to the present invention comprises mixing

at least one disperse dye,

at least two wetting agents,

if appropriate at least one dispersant,

water and

if appropriate further assistants

with each other in one or more steps.

In one embodiment of the production process according to the present invention at least one disperse dye (a), for example in the form of an aqueous press cake, is premixed together with at least one wetting agent (b) and water (d) in a suitable apparatus, for example a dissolver. The resulting mixture is subsequently dispersed, for example in a mill or in a shaking apparatus, to achieve the desired particle size for the disperse dye or dyes (generally a number average diameter up to 1 μm, preferably up to 0.5 μm and more preferably up to 0.3 μm). This is followed by the addition of at least one further wetting agent and if appropriate further assistants (e) and if appropriate further water (d).

In another embodiment of the production process according to the present invention at least one disperse dye (a) for example in the form of an aqueous press cake, is premixed together with at least one dispersant (c) and water (d) in a suitable apparatus, for example a dissolver. The resulting mixture is subsequently dispersed, for example in a mill or in a shaking apparatus, to achieve the desired particle size for the disperse dye or dyes (generally a number average diameter up to 1 μm, preferably up to 0.5 μm and more preferably up to 0.3 μm). This is followed by the addition of at least two wetting agents and if appropriate further assistants (e) and if appropriate further water (d).

The final step in each case can be a filtration through filtering means with fines removal in the range from 1 to 0.5 μm. This is one way of obtaining recording fluids according to the present invention and especially ink jet inks according to the present invention.

Recording fluids according to the present invention can be used directly as inks or to produce inks, for example for the ink jet process. Recording fluids according to the present invention can especially be used directly as or to produce ink jet process inks. Other suitable inks are for example inks for fountain pens. A further aspect of the present invention is therefore the use of recording fluids according to the present invention as inks for the ink jet process. A further aspect of the present invention is a process for printing substrates using recording fluids according to the present invention.

To use recording fluids according to the present invention to produce inks, the next step will generally be for recording fluids according to the present invention to be diluted, for example with water which may comprise one or more further of the assistants (e) mentioned above. Diluting may be accompanied by mixing, for example stirring.

A further aspect of the present invention is a process for printing substrates, which can be sheetlike or three dimensional for example, by the ink jet process using recording fluids according to the present invention or inks according to the present invention. To this end, recording fluids or ink jet process inks according to the present invention are printed on the substrate and the print obtained can subsequently be fixed.

In the ink jet process, inks are sprayed as small droplets directly onto the substrate. There is a continuous form of the process, in which the ink is pressed at a uniform rate through a nozzle and the jet is directed onto the substrate by an electric field depending on the pattern to be printed, and there is an interrupted or drop-on-demand process, in which the ink is expelled only where a colored dot is to appear, the latter form of the process employing either a piezoelectric crystal or a heated hollow needle (bubble or thermal jet process) to exert pressure on the ink system and so eject an ink droplet. These techniques are described in Text. Chem. Color 19 (1987), No. 8, 23-29, and 21 (1989), No. 6, 27-32.

The inks of the invention are useful as inks for the bubble jet process or the process employing a piezoelectric crystal.

Useful substrate materials include:
cellulosic materials such as paper, paperboard, cardboard, wood and woodbase, which may each be lacquered or otherwise coated,
metallic materials such as foils, sheets or workpieces composed of aluminum, iron, copper, silver, gold, zinc or alloys thereof, which may each be lacquered or otherwise coated,
silicatic materials such as glass, porcelain and ceramic, which may likewise each be coated,
polymeric materials of any kind such as polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers including block copolymers, biodegradable polymers and natural polymers such as gelatin,
leather—both natural and artificial—in the form of smooth leather, nappa leather or suede leather,
comestibles and cosmetics,
   and in particular
textile substrates and sheetlike structures such as wovens, knit fabric, woven fabric, nonwovens and made-up fabric composed for example of polyester, modified polyester, blend fabrics from more than two materials such as polyester blend wovens and cotton blend wovens, cellulosic materials such as cotton, jute, flax, hemp and ramie, viscose, wool, silk, polyamide, polyamide blend wovens, polyacrylonitrile, polyurethane, polytetrahydrofuran, triacetate, acetate, polycarbonate, polypropylene, polyvinyl chloride, polyester microfibers and glass fiber wovens.

In one embodiment of the present invention the present invention's process for printing substrates is a transfer process. The transfer process is practiced by initially using one or more recording fluids according to the present invention or combinations of at least one recording fluid according to the present invention and one or more conventional recording fluids comprising disperse dye to print a pattern onto transfer paper and subsequently effecting a transfer to a preferably polyester-comprising substrate. The transfer to preferably polyester-comprising substrate takes place at transfer temperatures of generally 200 to 250° C.

In one embodiment of the present invention the present invention's process for printing substrates is a process for printing textile substrates.

In one embodiment of the present invention the present invention's process for printing substrates is a process for printing substrates comprising polyester and preferably textile substrates consisting of polyester.

Recording fluids according to the present invention and ink jet process inks according to the present invention have altogether advantageous performance properties, especially good start-of-print performance and good sustained use performance (kogation) and also good holdout, and produce printed images of high quality, i.e., of high brilliance and depth of shade and also high rub-, light-, water- and wet rubfastness, washfastness and also stability to chemical dry cleaning. They are particularly useful for printing coated and plain paper and also textile substrates.

A further embodiment of the present invention provides substrates, especially textile substrates, which have been printed by one of the abovementioned inventive processes and are notable for particularly crisply printed pictures or drawings and also excellent hand.

In a further embodiment of the present invention, at least two and preferably at least four different recording fluids according to the present invention can be combined into sets, for example in the color combination of yellow-magenta-cyan-black.

The invention is illustrated by working examples.

Unless stated otherwise, water (d) hereinbelow always refers to water which has been rendered completely ion-free by deionization using ion exchangers.

1. Production of Colorant Preparations

Each colorant preparation was produced as a grind by using a 100 ml capacity Skandex shaker filled with 60 g of glass balls 0.55 mm in average diameter.

1.1. Production of a Red Colorant Preparation

The following were weighed into the shaker:

15 g of Disperse Red 60 dye

7.5 g of polyethylene glycol of molecular weight M_{w} of 600 g/mol

15 g of dispersant (c.1) (dispersing agent from Example 3 of U.S. Pat. No. 5,186,848)

0.5 g of triethanolamine

62 g of water

A red colorant preparation F.1 was obtained after shaking for 4 hours. The average particle diameter of the colorant was determined by means of a Coulter LS230 Coulter Counter as a number average diameter of 210 nm. The disperse dye particles were not polymer covered.

1.2. Production of a Blue Colorant Preparation

The 1.1 procedure was repeated except that Disperse Red 60 was replaced by Disperse Blue 72. A blue colorant preparation F.2 was obtained. The average particle diameter of the colorant was determined by means of a Coulter LS230 Coulter Counter as a number average diameter of 265 nm. The disperse dye particles were not polymer covered.

2. Production of Inventive Recording Fluids and of Comparative Fluids

General Protocol:

The ingredients of Table 1 were each added together in the order evident from the table and thoroughly mixed through by stirring. The addition of each colorant preparation was followed by a further 15 minutes of stirring. This was followed by filtration through a filter 1 μm in pore size to obtain the inventive recording fluids (inks) as per Table 1.

TABLE 1
Production of inventive inks T.1 to T.6 and comparative inks V-T.7 to V-T.9

| | | | | | Colorant |
|---|---|---|---|---|---|
| No. | (e) | (b1) | (b2) | (d) [g] | preparation |
| T.1 | 7 g glycerol, 5 g PE40, 4 g 1,2-pentanediol, 0.48 g BIT | B1 (0.15 g) | B2 (0.4 g) | 58.15 | 24.82 g F.1 |
| T.2 | 6 g glycerol, 6 g PE40, 4.5 g 1,2-pentanediol, 0.48 g BIT | B1 (0.15 g) | B2 (0.15 g) | 52.37 | 30.4 g F.2 |
| T.3 | 6 g glycerol, 3 g PE40, 3 g 1,2-pentanediol, 0.48 g BIT | B2 (0.1 g) | B3 (0.15 g) | 56.87 | 30.4 g F.2 |
| T.4 | 6 g glycerol, 3 g PE40, 4 g 1,2-pentanediol, 0.48 g BIT | B1 (0.1 g) | B3 (0.15 g) | 61.45 | 24.82 g F.1 |
| T.5 | 8 g glycerol, 5 g PE40, 4 g 1,2-pentanediol, 0.48 g BIT | B1 (0.2 g) | B3 (0.25 g) | 59.25 | 24.82 g F.1 |
| T.6 | 10 g glycerol, 4 g PE40, 2.5 g 1,2-pentanediol, 0.48 g BIT | B2 (0.25 g) | B3 (0.15 g) | 52.22 | 30.4 g F.2 |
| V-T.7 | 6 g glycerol, 3 g PE40, 4 g 1,2-pentanediol, 0.48 g BIT | — | B3 (0.15 g) | 61.8 | 30.4 g F.1 |
| V-T.7a | 6 g glycerol, 3 g PE40, 4 g 1,2-pentanediol, 0.48 g BIT | — | B3 (0.25 g) | 61.7 | 30.4 g F.1 |
| V-T.9 | 6 g glycerol, 3 g PE40, 3 g 1,2-pentanediol, 0.48 g BIT | B2 (0.3 g) | — | 56.82 | 30.4 g F.2 |

Abbreviations used: PE40: polyethylene glycol having an M_{w} of 400 g/mol, BIT: 20% by weight solution of 1,2-benzisothiazolin-3-one in propylene glycol 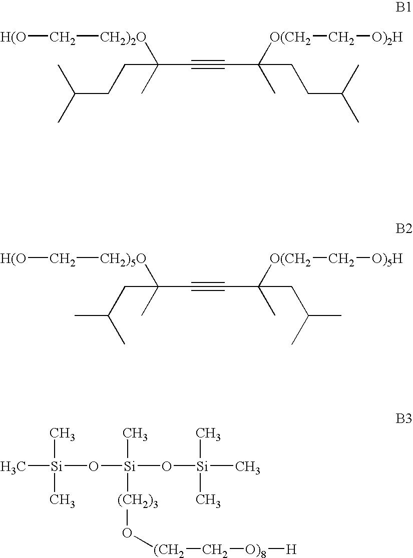
3. Printing Tests with Inventive Recording Fluids and with Comparative Fluids

The inventive recording fluids were each filled into one cartridge per recording fluid. Similarly, the comparative fluids were filled into one cartridge each.

Printing tests were carried out with a Mimaki TX2 ink jet printer on water-resistant ink jet paper. Each ink was used to print a solid area in 8 passes at a resolution of 720×720 dpi. The results are summarized in Table 2.

4. Storage Test

The inventive recording fluids were each stored at 60° C. for 5 days. Thereafter, the colorant particles were visually examined by means of a Leica DMLM microscope.

No particle growth of the disperse dye particles was observed in the case of the inventive recording fluids. Comparative recording fluid V-T.7 was observed to have produced a small but significant degree of growth of the disperse dye particles and V-T.7a and V-T.9 were found to have produced severe growth of the disperse dye particles.

In addition, the DIN 53914 dynamic surface tension was measured in each case by means of a Lauda TE 1C surface tension meter before and after storage of inventive recording fluids. The results are summarized in the last column of Table 2.

TABLE 2
Results of printing tests and of storage tests

| Printing | Recording | | | Comments | Δ surface |
|---|---|---|---|---|---|
| test | fluid | Nozzle result | | concerning | tension |
| No. | No. | Dropout | Misting | printing test | [mN/m] |
| 3.1 | T.1 | 2 | 3 | little foam | 0.1 |
| 3.2 | T.2 | 2 | 3 | no foam | 0.2 |
| 3.3 | T.3 | 2 | 3 | no foam | 0.15 |
| 3.4 | T.4 | 2 | 3 | no foam | 0.3 |
| 3.5 | T.5 | 2 | 3 | no foam | 0.1 |
| 3.6 | T.6 | 2 | 3 | little foam | 0.4 |
| 3.7 | V-T.7 | 2 | 3 | substantial foam | 2 |
| 3.8 | V-T.7a | — | — | ink blots | n.d. |
| 3.9 | V-T.9 | 5 | 13 | substantial foam | 0.5 |

n.d.: not determined.

1. An aqueous recording fluid comprising
(a) at least one disperse dye, and
(b) at least two wetting agents that are selected from (1) acetylene derivatives or (2) acetylene derivatives and alkoxylated or nonalkoxylated silicones.

2. The recording fluid according to claim 1 wherein at least two wetting agents are selected from (b1) alkoxylated silicones and (b) alkoxylated or nonalkoxylated acetylene derivatives.

3. The recording fluid according to claim 1 further comprising
(c) at least one dispersant.

4. The recording fluid according to claim 1 that comprises two wetting agents whose weight ratio is in the range from 1:20 to 20:1.

5. The recording fluid according to claim 1 comprising up to 2% by weight of (b), based on the total weight of the recording fluid.

6. A process for producing a recording fluid according to claim 1, which comprises mixing
(a) at least one disperse dye,
(b) at least two wetting agents that are selected from (1) acetylene derivatives or (2) acetylene derivatives and alkoxylated or nonalkoxylated silicones,
(c) if appropriate at least one dispersant,
(d) water and
(e) if appropriate further assistants
with each other in one or more steps.

7. An ink for an ink jet process comprising a recording fluid according to claim 1.

8. A process for printing substrates by the ink jet process comprising using a recording fluid according to claim 1.

9. The process according to claim 8 that is a transfer process.

10. The process according to claim 8 wherein the substrates are textile substrates.

11. The process according to claim 8 wherein the substrates are substrates comprising polyester.

12. A printed substrate obtained by a process according to claim 8.
